(19) United States
(12) Patent Application Publication
(10) Pub. No.: US 2013/0188069 A1
(43) Pub. Date: Jul. 25, 2013

(54) METHODS AND APPARATUSES FOR RECTIFYING ROLLING SHUTTER EFFECT

(71) Applicants: Omry Sendik, Givatayim (IL); German Voronov, Holon (IL); Michael Slutsky, Kfar Saba (IL)

(72) Inventors: Omry Sendik, Givatayim (IL); German Voronov, Holon (IL); Michael Slutsky, Kfar Saba (IL)

(73) Assignee: SAMSUNG ELECTRONICS CO., LTD., Suwon-si (KR)

(21) Appl. No.: 13/354,983

(22) Filed: Jan. 20, 2012

(51) Int. Cl. H04N 5/225

(52) U.S. Cl. 348/222.1; 348/E05.024

(57) ABSTRACT

In a method for rectifying rolling shutter effects, a horizontal translation and a vertical translation of a second image relative to a first image are estimated, and the estimated horizontal and vertical translations are filtered using a Kalman filter. Rolling shutter distortion of the second image is rectified according to the filtered horizontal and vertical translations.

### BACKGROUND

1. Field

At least some example embodiments of inventive concepts relate to image sensing systems, for example, methods and apparatuses for rectifying rolling shutter effects using a Kalman filter.

2. Description of Conventional Art

Rolling shutter effects are usually found in a video or digital still camera including complementary metal oxide semiconductor (CMOS) image sensors. In these example devices, each frame is recorded by scanning across the frame either vertically or horizontally, rather than from a snapshot of a single point in time. Because all parts of an image are not recorded at exactly the same time, the image may bend in one direction or another as the camera or object moves from one side to another. As a result, image distortion may occur.

### SUMMARY

At least one example embodiment is directed to a method for rectifying rolling shutter effect in an image signal processor. According to at least this example embodiment, the method includes: estimating horizontal translation and vertical translation of a second image relative to a first image; enhancing the horizontal translation and the vertical translation by using a Kalman filter; and rectifying rolling shutter distortion of the second image according to the enhanced horizontal translation and the enhanced vertical translation.

According to at least some example embodiments, a gain matrix of the Kalman filter is Kₖ=Pₖ⁻H^{T}(HP⁻ₖH^{T}+R)⁻¹, where Pₖ⁻ is a priori estimate error covariance, H is an output matrix, R is measurement error covariance, and k is a state. The (HP⁻ₖH^{T}+R) may be a diagonal matrix.

According to at least some example embodiments, the method for rectifying the rolling shutter effects in the image signal processor may further include resizing the rectified second image by using interpolation. The interpolation may be bilinear interpolation.

The rectifying the rolling shutter distortion may include applying an inverse affine transformation matrix according to the enhanced horizontal and vertical translations. The first image and the second image may be successive images.

At least one other example embodiment is directed to an image signal processor. According to at least this example embodiment, the image signal processor includes: a motion estimator configured to estimate a horizontal translation and a vertical translation of a second image relative to a first image; a Kalman filter unit configured to enhance the horizontal translation and the vertical translation; and an affine transformer configured to rectify rolling shutter distortion of the second image according to the enhanced horizontal translation and vertical translation.

At least one other example embodiment is directed to an image sensing system. According to at least this example embodiment, the image sensing system includes: an image signal processor; and a display unit configured to display images output from the image signal processor. The image signal processor includes: a motion estimator configured to estimate a horizontal translation and a vertical translation of a second image relative to a first image; a Kalman filter unit configured to enhance the horizontal translation and the vertical translation; and an affine transformer configured to rectify rolling shutter distortion of the second image according to the enhanced horizontal translation and vertical translation.

At least one other example embodiment provides a method for rectifying rolling shutter distortion in an image signal processor. According to this example embodiment, the method includes: estimating a horizontal translation and a vertical translation of a second image relative to a first image; filtering the horizontal translation and the vertical translation using a Kalman filter; and rectifying rolling shutter distortion of the second image based on the filtered and vertical translation.

According to at least some example embodiments, the method may further include: capturing the first image and the second image with an image sensor; and/or resizing the rectified second image using interpolation

The rectifying of the rolling shutter distortion may include applying an inverse affine transformation matrix according to the filtered horizontal translation and the filtered vertical translation.

The filtering of the horizontal and vertical translations may include: iteratively calculating a state vector indicative of the filtered horizontal and vertical translations; and determining the filtered horizontal and vertical translations based on the iteratively calculated state vector.

At least one other example embodiment provides an image signal processor. According to at least this example embodiment, the image signal processor includes: a motion estimator configured to estimate a horizontal translation and a vertical translation of a second image relative to a first image; a Kalman filter unit configured to filter the horizontal translation and the vertical translation; and an affine transformer configured to rectify rolling shutter distortion of the second image based on the filtered horizontal translation and the filtered vertical translation.

According to at least some example embodiments, the image signal processor may further include a controller configured to control an image sensor configured to capture the first image and the second image.

According to at least some example embodiments, the Kalman filter unit may be configured to iteratively calculate a state vector indicative of the filtered horizontal and vertical translations, and to determine the filtered horizontal and vertical translations based on the iteratively calculated state vector.

At least one other example embodiment provides an image sensing system. According to at least this example embodiment, the image sensing system includes: an image signal processor; and a display unit configured to display images output from the image signal processor. The image signal processor includes: a motion estimator configured to estimate a horizontal translation and a vertical translation of a second image relative to a first image; a Kalman filter unit configured to filter the horizontal translation and the vertical translation; and an affine transformer configured to rectify rolling shutter distortion of the second image based on the filtered horizontal translation and the filtered vertical translation.

At least one other example embodiment provides a method for rectifying rolling shutter effects between a first image and a second image. According to at least this example embodiment, the method includes: predicting, by an image signal processor, motion between the first image and the second image by estimating a horizontal and vertical shift between the first image and the second image using a Kalman filter; and rectifying, by the image signal processor, rolling shutter distortion of the second image based on the predicted motion.

According to at least some example embodiments, the method may further include determining an initial estimate of the horizontal and vertical shift between the first image and the second image. The motion may be predicted based on the determined initial estimate.

The rectifying of the rolling shutter distortion may include applying an inverse affine transformation matrix based on the estimated horizontal and vertical translations.

The estimating of the horizontal and vertical translations may include iteratively calculating a state vector indicative of the estimated horizontal and vertical translations. A current value of the state vector may be iteratively calculated based on previously calculated values of the state vector.

### BRIEF DESCRIPTION OF THE DRAWINGS

Example embodiments will become apparent and more readily appreciated from the following description of the accompanying drawings in which:

FIGS. 1A and 1B are images depicting example horizontal and vertical rolling shutter effects;

FIG. 2 is a block diagram of an image sensing system including an image signal processor according to an example embodiment;

FIG. 3 is a block diagram of an example embodiment of the central processing unit illustrated in FIG. 2;

FIGS. 4A and 4B depict example intensities of a first image and a second image, respectively;

FIG. 4C depicts an example image in which the first image and the second image overlap each other when u is 0 and v is 0;

FIG. 4D depicts an example image in which the first image and the second image overlap each other when u is 1 and v is 2;

FIGS. 5A to 5H depict example simulation graphs for explaining example operation of an example embodiment of the Kalman filter unit illustrated in FIG. 3;

FIG. 6 is a flowchart depicting a method for rectifying rolling shutter effects according to an example embodiment; and

FIG. 7 is a schematic block diagram of an image sensing system according to another example embodiment.

### DETAILED DESCRIPTION

Example embodiments will now be described more fully with reference to the accompanying drawings, in which some example embodiments are shown. In the drawings, the thicknesses of layers and regions are exaggerated for clarity. Like reference numerals in the drawings denote like elements.

Detailed illustrative embodiments are disclosed herein. However, specific structural and functional details disclosed herein are merely representative for purposes of describing example embodiments. Example embodiments may be embodied in many alternate forms and should not be construed as limited to only those set forth herein.

It should be understood, however, that there is no intent to limit this disclosure to the particular example embodiments disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of this disclosure. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

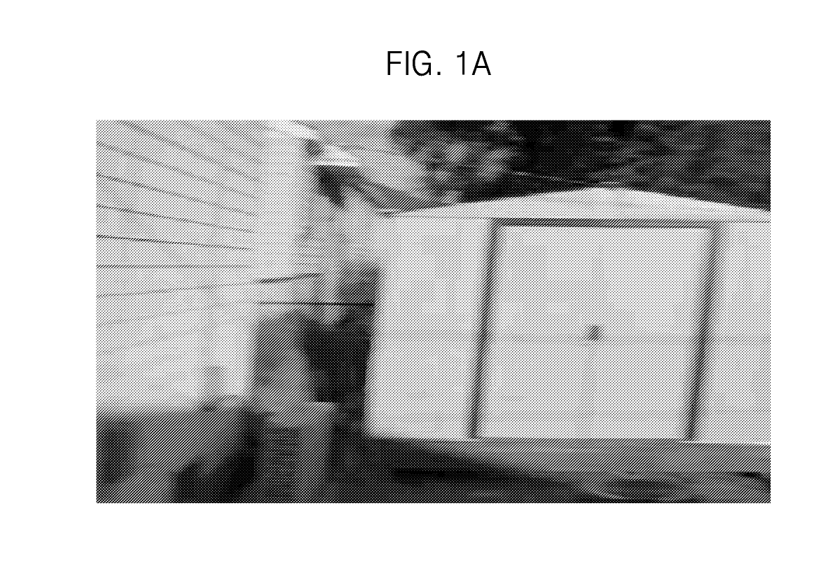

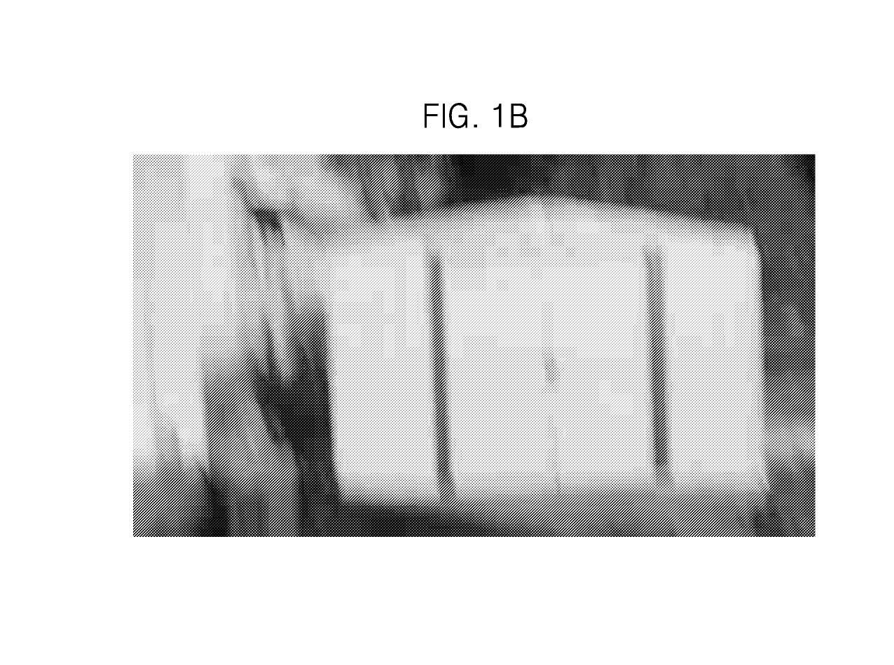

FIGS. 1A and 1B are images depicting example horizontal and vertical rolling shutter effects. The image distortion shown in FIGS. 1A and 1B may be caused when a camera moves during image capture. In FIG. 1A, the house appears skewed as the camera pans horizontally. In FIG. 1B, the house appears wobbled as the camera pans vertically.

Rolling shutter effects such as those shown in FIGS. 1A and 1B may degrade (e.g., seriously or substantially degrade) visual quality of images.

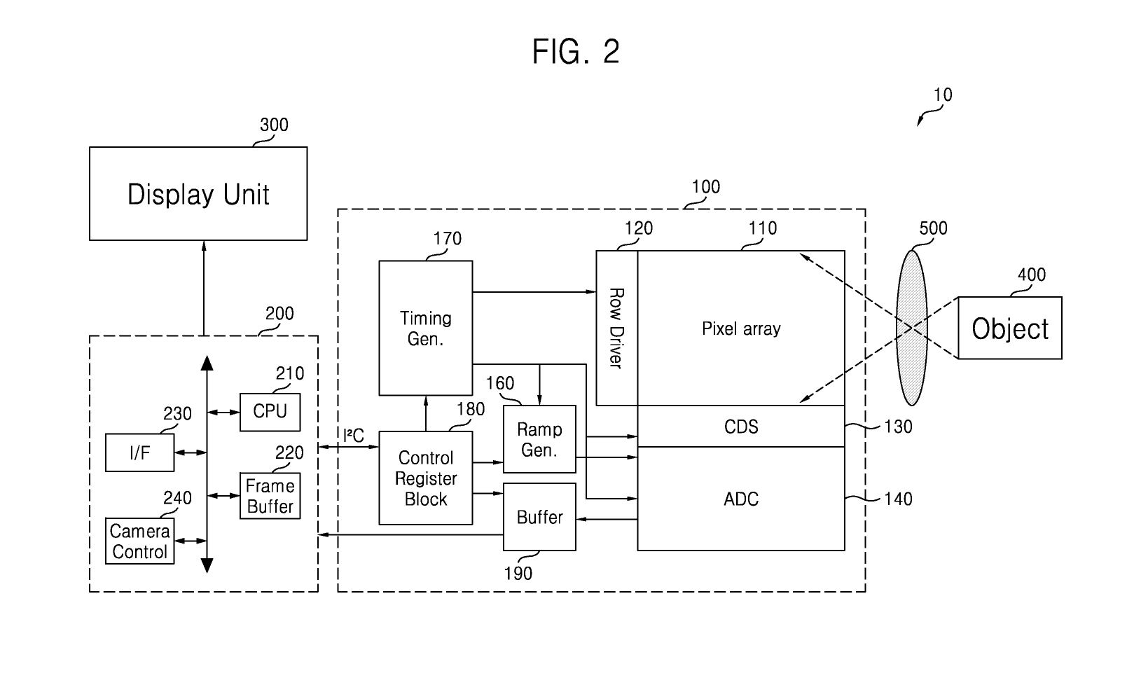

FIG. 2 is a block diagram of an image sensing system according to an example embodiment.

Referring to FIG. 2, the image sensing system 10 includes an image sensor 100, an image signal processor (ISP) 200 and a display unit 300.

The image sensor 100 includes a pixel array (e.g., an active pixel sensor (APS)) 110, a row driver 120, a correlated double sampling (CDS) block 130, an analog digital converter (ADC) 140, a ramp signal generator 160, a timing generator 170, a control register block 180 and a buffer 190.

In example operation, the image sensor 100 senses an object 400 captured through a lens 500 and outputs corresponding electrical image data under the control of the ISP 200. In so doing, the image sensor 100 converts a sensed optical image into electrical image data and outputs the electrical image data.

The pixel array 110 may include a plurality of optical sensing elements, such as photo diodes, pinned photo diodes, or the like. The plurality of optical sensing elements of the pixel array 110 are configured to sense incident light, and the pixel array 110 converts the sensed light into electric signal(s) to generate image data.

The timing generator 170 outputs control signals to each of the row driver 120, the ADC 140 and the ramp signal generator 160 to control operations of each of these components. A control register block 180 also outputs control signals to each of the ramp signal generator 160, the timing generator 170 and the buffer 190 to control operations of each of these components. In this example, the camera controller 240 controls the control register block 180. According to at least this example embodiment, the ramp signal generator 160 operates under the control of the timing generator 170 and the control register block 180.

Still referring to FIG. 2, the row driver 120 drives the pixel array 110 on a row-by-row basis. For example, the row driver 120 generates a row selection signal, and outputs the generated row selection signal to select a row of the pixel array 110. In response to the row selection signal, the pixel array 110 outputs a reset signal and an image signal from the selected row to the CDS 130. The CDS 130 performs correlated double sampling on each of the reset signal and the image signal from the selected row.

The ADC 140 compares a ramp signal supplied from the ramp signal generator 160 with the correlated double sampled signal output from the CDS 130 to generate a comparison signal. The ADC 140 counts the duration of a specific level of the comparison signal (e.g., high level or low level), and outputs the count result as a digital signal to the buffer 190.

The buffer 190 stores, senses and amplifies the digital signal output from the ADC 140. The buffer 190 then outputs the amplified digital signal to the ISP 200. In this example, the buffer 190 may include a sense amplifier (SA) for sensing and amplifying a digital signal Output from a plurality of column memory blocks (e.g., a static random access memory (SRAM)) in each column for temporary storage and the ADC 140.

The ISP 200 processes image data from the image sensor 100, and outputs the processed image data to a display unit 300. In this example, the display unit 300 may be any apparatus capable of displaying an image. For example, the display unit 300 may be a computer, a monitor, an output terminal of a mobile or other communication device and other image output terminals.

Still referring to FIG. 2, the ISP 200 includes a central processing unit (CPU) 210, a frame buffer, 220, an interface (I/F) 230 and a camera controller 240.

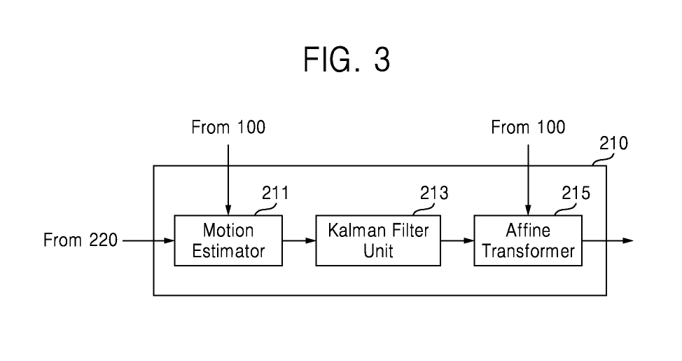

In example operation, the CPU 210 receives image data in the form of the amplified digital signal from the buffer 190, and performs a processing operation to generate an image corresponding to the received image data. The CPU 210 then outputs the processed image to the display unit 300 through the I/F 230. The processing operations of the CPU 210 are described in more detail with regard to FIG. 3.

According to at least some example embodiments, the frame buffer 220 may be embodied in the same or a separate chip as the ISP 200.

The camera controller 240 controls the image sensor 100 through control of the control register block 180. In this example, the camera controller 240 controls the control register block 180 using an inter-integrated circuit (I²C). However, example embodiments are not limited to this example.

FIG. 3 is a block diagram of an example embodiment of the CPU 210 illustrated in FIG. 2.

Referring to FIG. 3, the CPU 210 includes a motion estimator 211, a Kalman filter unit 213 and an affine transformer 215.

The motion estimator 211, the Kalman filter unit 213 and/or the affine transformer 215 may be embodied by hardware, software, firmware, middleware, microcode, hardware description languages, or any combination thereof. If implemented in software, firmware, middleware or microcode, then the program code or code segments to perform the necessary tasks may be stored in a machine or computer readable medium such as a computer readable storage medium. When implemented in software, a processor or processors (e.g., CPU 210) may perform the necessary tasks. Example hardware implementations include one or more Central Processing Units (CPUs), digital signal processors (DSPs), application-specific-integrated-circuits, field programmable gate arrays (FPGAs) computers, etc.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to portable or fixed storage devices, optical storage devices, and various other mediums capable of storing, containing or carrying instruction(s) and/or data.

Still referring to FIG. 3, in example operation the motion estimator 211 estimates a horizontal translation Δx and a vertical translation Δy of a second image relative to a first image. In this example, the second image is captured by the image sensor 100 subsequent to the first image.

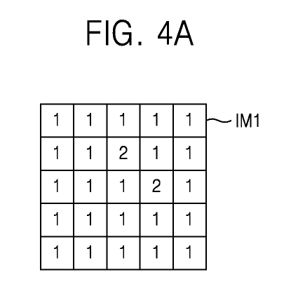

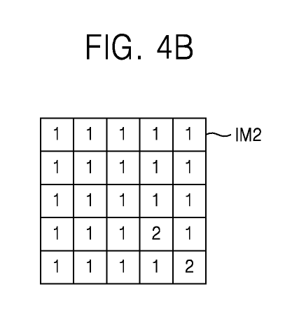

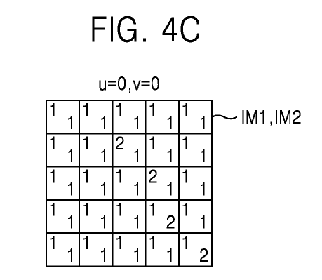

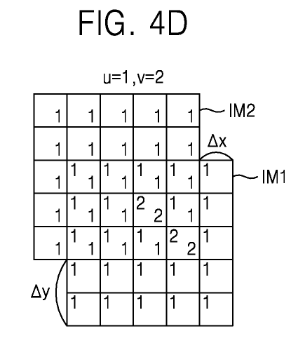

FIGS. 4A and 4B depict example intensities of a first image and a second image for explaining example operation of the motion estimator 211 illustrated in FIG. 3.

In FIGS. 4A and 4B, the first image IM1 and the second image IM2 are 5×5 pixel arrays. However, example embodiments are not limited to the number of pixels in this example.

Referring to FIGS. 2, 3, 4A and 4B, the frame buffer 220 outputs the first image IM1 and the image sensor 100 outputs the second image IM2. The first image IM1 and the second image IM2 are successive images. For example, the first image IM 1 is a previous image captured prior to the second image IM2, which is a current image.

In this example, the first image IM1 and the second image IM2 may be referred to as a first frame and a second frame or first image data and second image data, respectively. And, it is assumed that the second image IM2 is shifted or moves one pixel to the right and two pixels down relative to the first image IM1. In addition, it is assumed that enough content between the first image IM1 and the second image IM2 remains relatively unaltered, which is a reasonable assumption when capturing images using common and/or conventional frame rates at reasonable motion speeds.

The motion estimator 211 shown in FIG. 3 estimates motion or shift between the first image IM1 and the second image IM2 by calculating a cross correlation matrix between the first image IM1 and the second image IM2. To reduce (e.g., minimize) effects of diversity of light, noise and exposure time, the motion estimator 211 may use a normalized cross correlation.

In one example, the motion estimator 211 calculates the normalized cross correlation as shown below in an Equation 1.

$$XCR ( u , v ) = \frac{{\sum }_{m , n} ( {I}_{1} ( {m}_{2} , n ) - {μ}_{1} ( u , v ) ) ( ( {I}_{2} ( m - u , n - v ) - {μ}_{2} ) )}{( \sqrt{\begin{matrix}{\sum }_{m , n} {( {I}_{1} ( m , n ) - {μ}_{1} ( u , v ) )}^{2} \\ {\sum }_{m , n} {( {I}_{2} ( m - u , n - v ) - {μ}_{2} )}^{2}\end{matrix}} )} \qquad [ Equation 1 ]$$

In Equation 1, I₁ is an intensity of the first image IM1, I₂ is an intensity of the second image IM2, (m,n) is a pixel index of the first image IM1, and (m-u,n-v) is a pixel index of the second image IM2. Still referring to Equation 1, μ₁ is an average intensity of the first image IM1, and μ₂ is an average intensity of the second image IM2. Each of indices u and v represents the amount of movement of the second image IM2 relative to a center of the first image IM1.

FIG. 4C depicts an example overlap between the first image IM1 and the second image IM2 for explaining example operation of the motion estimator 211 illustrated in FIG. 3 when the indices u and v are both 0. In this example, the second image IM2 is not shifted relative to the first image IM1.

Referring to FIG. 4C, in this example, an average intensity μ₁ of the first image IM1 is calculated as shown below in Equation 2, and an average intensity μ₂ of the second image IM2 is calculated as shown below in Equation 3.

$$\begin{matrix}{μ}_{1} = \frac{( \begin{matrix}1 + 1 + 1 + 1 + 1 + 1 + 1 + 2 + 1 + \\ 1 + 1 + 1 + 1 + 2 + 1 + 1 + 1 + \\ 1 + 1 + 1 + 1 + 1 + 1 + 1 + 1\end{matrix} )}{5 \times 5} = \frac{27}{25} & [ Equation 2 ] \\ {μ}_{2} = \frac{( \begin{matrix}1 + 1 + 1 + 1 + 1 + 1 + 1 + 1 + 1 + \\ 1 + 1 + 1 + 1 + 1 + 1 + 1 + 1 + \\ 1 + 2 + 1 + 1 + 1 + 1 + 1 + 2\end{matrix} )}{5 \times 5} = \frac{27}{25} & [ Equation 3 ]\end{matrix}$$

Given Equations 1 through 3, an example calculation of the normalized cross correlation by the motion estimator 211 when u is 0 and v is 0 is shown below in Equation 4.

$$\begin{matrix}XCR ( u = 0 , v = 0 ) = \frac{{\sum }_{m , n} ( {I}_{1} ( m , n ) - {μ}_{1} ( u , v ) ) ( {I}_{2} ( m - u , n - v ) - {μ}_{2} )}{( \sqrt{{\sum }_{m , n} {( {I}_{1} ( m , n ) - {μ}_{1} ( u , v ) )}^{2} {\sum }_{m , n} {( {I}_{2} ( m - u , n - v ) - {μ}_{2} )}^{2}} )} = \\ = \frac{Σ [ ( \begin{matrix}1 & 1 & 1 & 1 & 1 \\ 1 & 1 & 2 & 1 & 1 \\ 1 & 1 & 1 & 2 & 1 \\ 1 & 1 & 1 & 1 & 1 \\ 1 & 1 & 1 & 1 & 1\end{matrix} - \frac{27}{25} ) ( \begin{matrix}1 & 1 & 1 & 1 & 1 \\ 1 & 1 & 1 & 1 & 1 \\ 1 & 1 & 1 & 1 & 1 \\ 1 & 1 & 1 & 2 & 1 \\ 1 & 1 & 1 & 1 & 2\end{matrix} - \frac{27}{25} ) ]}{\sqrt{{{[ Σ ( \begin{matrix}1 & 1 & 1 & 1 & 1 \\ 1 & 1 & 2 & 1 & 1 \\ 1 & 1 & 1 & 2 & 1 \\ 1 & 1 & 1 & 1 & 1 \\ 1 & 1 & 1 & 1 & 1\end{matrix} - \frac{27}{25} ) ]}^{2} [ Σ ( \begin{matrix}1 & 1 & 1 & 1 & 1 \\ 1 & 1 & 1 & 1 & 1 \\ 1 & 1 & 1 & 1 & 1 \\ 1 & 1 & 1 & 2 & 1 \\ 1 & 1 & 1 & 1 & 2\end{matrix} - \frac{27}{25} ) ]}^{2}}} = \\ = \frac{Σ [ ( \begin{matrix}\frac{- 2}{25} & \frac{- 2}{25} & \frac{- 2}{25} & \frac{- 2}{25} & \frac{- 2}{25} \\ \frac{- 2}{25} & \frac{- 2}{25} & \frac{- 2}{25} & \frac{- 2}{25} & \frac{- 2}{25} \\ \frac{- 2}{25} & \frac{- 2}{25} & \frac{- 2}{25} & \frac{23}{25} & \frac{- 2}{25} \\ \frac{- 2}{25} & \frac{- 2}{25} & \frac{- 2}{25} & \frac{- 2}{25} & \frac{- 2}{25} \\ \frac{- 2}{25} & \frac{- 2}{25} & \frac{- 2}{25} & \frac{- 2}{25} & \frac{- 2}{25}\end{matrix} ) ( \begin{matrix}\frac{- 2}{25} & \frac{- 2}{25} & \frac{- 2}{25} & \frac{- 2}{25} & \frac{- 2}{25} \\ \frac{- 2}{25} & \frac{- 2}{25} & \frac{- 2}{25} & \frac{- 2}{25} & \frac{- 2}{25} \\ \frac{- 2}{25} & \frac{- 2}{25} & \frac{- 2}{25} & \frac{- 2}{25} & \frac{- 2}{25} \\ \frac{- 2}{25} & \frac{- 2}{25} & \frac{- 2}{25} & \frac{23}{25} & \frac{- 2}{25} \\ \frac{- 2}{25} & \frac{- 2}{25} & \frac{- 2}{25} & \frac{- 2}{25} & \frac{23}{25}\end{matrix} ) ]}{\sqrt{{{[ Σ ( \begin{matrix}\frac{- 2}{25} & \frac{- 2}{25} & \frac{- 2}{25} & \frac{- 2}{25} & \frac{- 2}{25} \\ \frac{- 2}{25} & \frac{- 2}{25} & \frac{23}{25} & \frac{- 2}{25} & \frac{- 2}{25} \\ \frac{- 2}{25} & \frac{- 2}{25} & \frac{- 2}{25} & \frac{23}{25} & \frac{- 2}{25} \\ \frac{- 2}{25} & \frac{- 2}{25} & \frac{- 2}{25} & \frac{- 2}{25} & \frac{- 2}{25} \\ \frac{- 2}{25} & \frac{- 2}{25} & \frac{- 2}{25} & \frac{- 2}{25} & \frac{- 2}{25}\end{matrix} ) ]}^{2} [ Σ ( \begin{matrix}\frac{- 2}{25} & \frac{- 2}{25} & \frac{- 2}{25} & \frac{- 2}{25} & \frac{- 2}{25} \\ \frac{- 2}{25} & \frac{- 2}{25} & \frac{- 2}{25} & \frac{- 2}{25} & \frac{- 2}{25} \\ \frac{- 2}{25} & \frac{- 2}{25} & \frac{- 2}{25} & \frac{- 2}{25} & \frac{- 2}{25} \\ \frac{- 2}{25} & \frac{- 2}{25} & \frac{- 2}{25} & \frac{23}{25} & \frac{- 2}{25} \\ \frac{- 2}{25} & \frac{- 2}{25} & \frac{- 2}{25} & \frac{- 2}{25} & \frac{23}{25}\end{matrix} ) ]}^{2}}} = \\ = Σ [ ( \begin{matrix}\frac{4}{625} & \frac{4}{625} & \frac{4}{625} & \frac{4}{625} & \frac{4}{625} \\ \frac{4}{625} & \frac{4}{625} & \frac{4}{625} & \frac{4}{625} & \frac{4}{625} \\ \frac{4}{625} & \frac{4}{625} & \frac{4}{625} & \frac{- 46}{625} & \frac{4}{625} \\ \frac{4}{625} & \frac{4}{625} & \frac{4}{625} & \frac{- 46}{625} & \frac{4}{625} \\ \frac{4}{625} & \frac{4}{625} & \frac{4}{625} & \frac{4}{625} & \frac{- 46}{625}\end{matrix} ) ] \\ = \frac{- 0.16}{1.84} \\ = - 0.087\end{matrix} \qquad [ Equation 4 ]$$

As shown in Equation 4, the normalized cross correlation value when u and v are both 0 is −0.087.

FIG. 4D depicts an overlap between the first image IM1 and the second image IM2 for explaining example operation of the motion estimator 211 illustrated in FIG. 3 when u is 1 and v is 2. In this example, the second image IM2 is shifted relative to the first image IM1.

Referring to FIGS. 2 and 4D, a 3×4 pixel area of the first image IM1 and the second image IM2 overlap. Thus, in this example, a range of m is between 1 and 3, inclusive, and a range of n is between 1 and 4, inclusive.

When u is 1 and v is 2, the average intensity μ₁ of the first image IM1 is calculated as shown below in Equation 5 and the average intensity μ₂ of the second image IM2 is calculated as shown below in Equation 6.

$$\begin{matrix}{μ}_{1} = \frac{( 1 + 1 + 1 + 1 + 1 + 1 + 2 + 1 + 1 + 1 + 1 + 2 )}{3 \times 4} = \frac{14}{12} & [ Equation 5 ] \\ {μ}_{2} = \frac{( 1 + 1 + 1 + 1 + 1 + 1 + 2 + 1 + 1 + 1 + 1 + 2 )}{3 \times 4} = \frac{14}{12} & [ Equation 6 ]\end{matrix}$$

Given Equations 1, 5 and 6, an example calculation of the normalized cross correlation by the motion estimator 211 when u is 1 and v is 2 is shown below in Equation 7.

$$\begin{matrix}XCR ( u = 1 , v = 2 ) = \frac{{\sum }_{m , n} ( {I}_{1} ( m , n ) - {μ}_{1} ( u , v ) ) ( {I}_{2} ( m - u , n - v ) - {μ}_{2} )}{( \sqrt{{\sum }_{m , n} {( {I}_{1} ( m , n ) - {μ}_{1} ( u , v ) )}^{2} {\sum }_{m , n} {( {I}_{2} ( m - u , n - v ) - {μ}_{2} )}^{2}} )} = \\ = \frac{Σ [ ( \begin{matrix}\frac{- 2}{12} & \frac{- 2}{12} & \frac{- 2}{12} & \frac{- 2}{12} \\ \frac{- 2}{12} & \frac{- 2}{12} & \frac{10}{12} & \frac{- 2}{12} \\ \frac{- 2}{12} & \frac{- 2}{12} & \frac{- 2}{12} & \frac{10}{12}\end{matrix} ) \begin{matrix}\frac{- 2}{12} & \frac{- 2}{12} & \frac{- 2}{12} & \frac{- 2}{12} \\ \frac{- 2}{12} & \frac{- 2}{12} & \frac{10}{12} & \frac{- 2}{12} \\ \frac{- 2}{12} & \frac{- 2}{12} & \frac{- 2}{12} & \frac{10}{12}\end{matrix} ]}{\sqrt{{{[ Σ \begin{matrix}\frac{- 2}{12} & \frac{- 2}{12} & \frac{- 2}{12} & \frac{- 2}{12} \\ \frac{- 2}{12} & \frac{- 2}{12} & \frac{10}{12} & \frac{- 2}{12} \\ \frac{- 2}{12} & \frac{- 2}{12} & \frac{- 2}{12} & \frac{10}{12}\end{matrix} ]}^{2} [ Σ \begin{matrix}\frac{- 2}{12} & \frac{- 2}{12} & \frac{- 2}{12} & \frac{- 2}{12} \\ \frac{- 2}{12} & \frac{- 2}{12} & \frac{10}{12} & \frac{- 2}{12} \\ \frac{- 2}{12} & \frac{- 2}{12} & \frac{- 2}{12} & \frac{10}{12}\end{matrix} ]}^{2}}} = \\ = \frac{Σ [ ( \begin{matrix}1 & 1 & 1 & 1 \\ 1 & 1 & 2 & 1 \\ 1 & 1 & 1 & 2\end{matrix} - \frac{14}{12} ) ( \begin{matrix}1 & 1 & 1 & 1 \\ 1 & 1 & 2 & 1 \\ 1 & 1 & 1 & 2\end{matrix} - \frac{14}{12} ) ]}{0} \\ = ∞\end{matrix} \qquad [ Equation 7 ]$$

As shown in Equation 7, the normalized cross correlation when u is 1 and v is 2 is equal to ∞.

The motion estimator 211 may calculate a normalized cross correlation for all values of u and v to generate a normalized cross correlation matrix XCR(u,v). An example normalized cross correlation matrix XCR(u,v) is shown below in Equation 8.

$$XCR ( u , {}^{c} v ) = ( \begin{matrix}- 0.0602 & - 0.0870 & - 0.1089 & - 0.1287 & - 0.1474 & - 0.1287 & - 0.1089 & - 0.0870 & - 0.0602 \\ - 0.0870 & - 0.1287 & - 0.1657 & - 0.2023 & - 0.2408 & - 0.2023 & - 0.1657 & - 0.1287 & - 0.0870 \\ - 0.1089 & 0.1795 & 0.0860 & 0.0118 & - 0.0602 & 0.0118 & - 0.2212 & - 0.1657 & - 0.1089 \\ - 0.1287 & 0.1138 & 0.3069 & 0.1730 & 0.1019 & 0.1730 & - 0.0103 & - 0.1905 & - 0.1287 \\ - 0.1474 & 0.0602 & 0.2408 & 0.1019 & - 0.0870 & 0.0687 & - 0.0864 & - 0.2212 & - 0.1382 \\ - 0.1287 & 0.1138 & 0.3069 & 0.1730 & 0.3578 & 0.1373 & - 0.0278 & - 0.1865 & - 0.1204 \\ - 0.1089 & 0.1795 & 0.3932 & 0.2465 & 0.1536 & ∞ & 0.0278 & - 0.1536 & - 0.1019 \\ - 0.0870 & - 0.1287 & 0.1795 & 0.0741 & 0.0092 & 0.0466 & 0.3263 & - 0.1209 & - 0.0821 \\ - 0.0602 & - 0.0870 & - 0.1089 & - 0.1287 & - 0.1382 & - 0.1204 & - 0.1019 & - 0.0821 & - 0.0602\end{matrix} ) \qquad [ Equation 8 ]$$

As shown above in Equation 8, a maximum value in the normalized cross correlation matrix is infinity, which corresponds to the situation in which u is 1 and v is 2.

The motion estimator 211 estimates the indices (u=1 and v=2) corresponding to the maximum value as the horizontal translation (Δx) and vertical translation (Δy), respectively, of the second image IM2 relative to the first image IM1. Thus, in this example, the initial estimate of the horizontal translation Δx is 1, and the initial estimate of the vertical translation Δy is 2. The Kalman filter unit 213 then enhances the horizontal translation Δx and the vertical translation Δy using a Kalman filter. A Kalman filter is based on a linear dynamic system, which is discrete in the time domain.

The Kalman filter unit 213 models a process by specifying the following matrices: the state-transition model A, the observation model H, the covariance of the process noise Q, the covariance of the measurement noise R and the control input model B, for each time step k. The Kalman filter unit 213 then uses these matrices to perform iterative calculations, which provide more accurate estimated values; in this case, more accurate estimates of the horizontal translation Δx and vertical translation Δy, thereby enhancing the horizontal translation Δx and vertical translation Δy. Operations of the Kalman filter unit 213 will be discussed in more detail below.

The Kalman filter unit 213 assumes the posteriori state Xₖ at time k is a function of the prior state Xₖ₋₁ at time (k−1) as shown below in Equation 9.

Xₖ=AXₖ₋₁+Buₖ+wₖ₋₁ [Equation 9]

In Equation 9, the posteriori state Xₖ is a linear combination of its previous state Xₖ₋₁, a control signal uₖ and process noise wₖ₋₁. The posteriori state Xₖ is a state vector and may be evaluated by using a linear stochastic equation. Also in Equation 9, A is the above-described state-transition model and B is the above-described control input model.

The Kalman filter unit 213 assumes a measurement value Zₖ of the posteriori state Xₖ at time k. The measurement value Zₖ is a linear combination of the posteriori state Xₖ and measurement noise hₖ as shown below in Equation 10.

Zₖ=HXₖ+hₖ [Equation 10]

In Equation 10, 1-1 is the above-described observation model and an output matrix, which maps a posteriori state space to an observed space.

The measurement value Zₖ may also be expressed as a function of the horizontal and vertical translation Δx and Δy. More specifically, for example, the measurement value Zₖ may be expressed as (Δx,Δy)^{T}.

The Kalman filter unit 213 also assumes the process noise wₖ and the measurement noise hₖ are zero mean Gaussian distributions, which are uncorrelated and statistically independent. And, the covariance Q of the process noise wₖ and covariance R of the measurement noise hₖ are given by Equations 11 and 12, respectively.

$$\begin{matrix}Q = ( \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & {σ}_{{a}_{x}}^{2} & 0 \\ 0 & 0 & 0 & 0 & 0 & {σ}_{{a}_{y}}^{2}\end{matrix} ) & [ Equation 11 ] \\ R = ( \begin{matrix}{σ}_{R}^{2} & 0 \\ 0 & {σ}_{R}^{2}\end{matrix} ) & [ Equation 12 ]\end{matrix}$$

In Equations 9 and 10, A, B and H are each in the general form of a matrix. The Kalman filter unit 213 assumes that A, B and H are constant or substantially constant. In one example, the Kalman filter unit 213 sets Xₖ, A, B and H as follows.

$${X}_{k} = {( \begin{matrix}{x}_{k} & {y}_{k} & {v}_{xk} & {v}_{yk} & {a}_{xk} & {a}_{yk}\end{matrix} )}^{T}$$

$$A = ( \begin{matrix}1 & 0 & Δ t & 0 & \frac{Δ {t}^{2}}{2} & 0 \\ 0 & 1 & 0 & Δ t & 0 & \frac{Δ {t}^{2}}{2} \\ 0 & 0 & 1 & 0 & Δ t & 0 \\ 0 & 0 & 0 & 1 & 0 & Δ t \\ 0 & 0 & 0 & 0 & 1 & 0 \\ 0 & 0 & 0 & 0 & 0 & 1\end{matrix} )$$

$$H = ( \begin{matrix}1 & 0 & Δ t & 0 & \frac{Δ {t}^{2}}{2} & 0 \\ 0 & 1 & 0 & Δ t & 0 & \frac{Δ {t}^{2}}{2}\end{matrix} )$$

$$B = 0$$

In this example, xₖ and yₖ are displacements, vₓₖ and v_{yk} are velocities, aₓₖ and a_{yk} are accelerations, and T is transpose. Also in this example, Δt is a time difference between a current state k and a previous state (k−1). The time difference Δt is equal to the reciprocal of the frame rate

$$FrameRate ( Δ t = \frac{1}{FrameRate} )$$

because the time between frames is

$$\frac{1}{FrameRate} .$$

Now having set sets Xₖ, A, B and H as discussed above, the Kalman filter unit 213 is able to calculate the state vector Xₖ based on the state vector in the previous state k−1 and the state-transition model A as shown below in Equation 13. In this example, the Kalman filter unit 213 assumes that acceleration is constant.

$${X}_{k} = {( \begin{matrix}{x}_{k} & {y}_{k} & {v}_{xk} & {v}_{yk} & {a}_{xk} & {a}_{yk}\end{matrix} )}^{T} \\ ( \begin{matrix}{x}_{k} \\ {y}_{k} \\ {v}_{xk} \\ {v}_{yk} \\ {a}_{xk} \\ {a}_{yk}\end{matrix} ) = {X}_{k} = {AX}_{k - 1} = ( \begin{matrix}1 & 0 & Δ t & 0 & \frac{Δ {t}^{2}}{2} & 0 \\ 0 & 1 & 0 & Δ t & 0 & \frac{Δ {t}^{2}}{2} \\ 0 & 0 & 1 & 0 & Δ t & 0 \\ 0 & 0 & 0 & 1 & 0 & Δ t \\ 0 & 0 & 0 & 0 & 1 & 0 \\ 0 & 0 & 0 & 0 & 0 & 1\end{matrix} ) ( \begin{matrix}{x}_{k - 1} \\ {y}_{k - 1} \\ {v}_{xk - 1} \\ {v}_{yk - 1} \\ {a}_{xk - 1} \\ {a}_{yk - 1}\end{matrix} ) ⇒ \\ {x}_{k} = {x}_{k - 1} + {v}_{xk - 1} Δ t + {a}_{xk - 1} \frac{Δ {t}^{2}}{2} \\ {y}_{k} = {y}_{k - 1} + {v}_{yk - 1} Δ t + {a}_{yk - 1} \frac{Δ {t}^{2}}{2} \\ {v}_{xk} = {v}_{xk - 1} + {a}_{xk - 1} Δ t \\ {v}_{yk} = {v}_{yk - 1} + {a}_{yk - 1} Δ t \\ {a}_{xk} = {a}_{xk - 1} \\ {a}_{yk} = {a}_{yk - 1} \qquad [ Equation 13 ]$$

After modeling the process by specifying the state-transition model A, the observation model H, the covariance of the process noise Q, the covariance of the measurement noise R and the control input model B, for each time step k, the Kalman filter unit 213 performs a Kalman filter operation. In performing the Kalman filter operation, the Kalman filter unit 213 computes a gain matrix Kₖ, and then updates the state vector Xₖ as shown below in Equation 14. Thus, the Kalman filter unit 213 updates the state vector Xₖ based on the computed gain matrix Kₖ.

Xₖ=Xₖ⁻+Kₖ(Zₖ−HXₖ⁻) [Equation 14]

In Equation 14, Xₖ⁻ is an a priori estimated state vector, Zₖ is the above-discussed measurement value, and H is the above-discussed observation model. In the initial calculation of Xₖ, the a priori estimated state vector Xₖ⁻ may be set to 0.

The Kalman filter unit 213 calculates the gain matrix Kₖ from Equation 14 as shown below in Equation 12.

Kₖ=Pₖ⁻H^{T}(HPₖ⁻H^{T}+R)⁻¹ [Equation 15]

In Equation 15, Pₖ⁻ is an a priori estimate error covariance, H is the above-described output matrix, R is a measurement error covariance, and k is the state. Thus, the Kalman filter unit 213 calculates the gain matrix Kₖ based on the a priori estimate error covariance Pₖ⁻ and the output matrix H. As mentioned above, T is the transpose, and thus, H^{T} is the transpose of the output matrix H.

The a priori estimate error covariance Pₖ⁻ in Equation 15 is also a matrix given by Equation 16 shown below.

$${P}_{k}^{-} = ( \begin{matrix}{σ}_{X}^{2} & 0 & {σ}_{{Xv}_{x}} & 0 & {σ}_{{Xa}_{x}} & 0 \\ 0 & {σ}_{Y}^{2} & 0 & {σ}_{{Yv}_{y}} & 0 & {σ}_{{Ya}_{y}} \\ {σ}_{{Xv}_{x}} & 0 & {σ}_{{v}_{x}}^{2} & 0 & {σ}_{{v}_{x} {a}_{x}} & 0 \\ 0 & {σ}_{{Yv}_{y}} & 0 & {σ}_{{v}_{y}}^{2} & 0 & {σ}_{{Ya}_{y}} \\ {σ}_{{Xa}_{x}} & 0 & {σ}_{{v}_{x} {a}_{x}} & 0 & {σ}_{{a}_{x}}^{2} & 0 \\ 0 & {σ}_{{Ya}_{y}} & 0 & {σ}_{{Ya}_{y}} & 0 & {σ}_{{a}_{y}}^{2}\end{matrix} ) \qquad [ Equation 16 ]$$

Due to the orthogonality of a vertical and horizontal axis, the Kalman filter unit 213 calculates the (HPₖ⁻H^{T}+R) term in Equation 15 as shown below in Equation 17.

$$\begin{matrix}{D}_{k} = ( {HP}_{0}^{-} {H}^{T} + R ) \\ = ( ( \begin{matrix}1 & 0 & Δ t & 0 & \frac{Δ {t}^{2}}{2} & 0 \\ 0 & 1 & 0 & Δ t & 0 & \frac{Δ {t}^{2}}{2}\end{matrix} ) ( \begin{matrix}{σ}_{X}^{2} & 0 & {σ}_{{Xv}_{x}} & 0 & {σ}_{{Xa}_{x}} & 0 \\ 0 & {σ}_{Y}^{2} & 0 & {σ}_{{Yv}_{y}} & 0 & {σ}_{{Ya}_{y}} \\ {σ}_{{Xv}_{x}} & 0 & {σ}_{{v}_{x}}^{2} & 0 & {σ}_{{v}_{x} {a}_{x}} & 0 \\ 0 & {σ}_{{Yv}_{y}} & 0 & {σ}_{{v}_{y}}^{2} & 0 & {σ}_{{Ya}_{y}} \\ {σ}_{{Xa}_{x}} & 0 & {σ}_{{v}_{x} {a}_{x}} & 0 & {σ}_{{a}_{x}}^{2} & 0 \\ 0 & {σ}_{{Ya}_{y}} & 0 & {σ}_{{Ya}_{y}} & 0 & {σ}_{{a}_{y}}^{2}\end{matrix} ) ( \begin{matrix}1 & 0 \\ 0 & 1 \\ Δ t & 0 \\ 0 & Δ t \\ \frac{Δ {t}^{2}}{2} & 0 \\ 0 & \frac{Δ {t}^{2}}{2}\end{matrix} ) + ( \begin{matrix}{σ}_{R}^{2} & 0 \\ 0 & {σ}_{R}^{2}\end{matrix} ) ) = \\ = ( ( \begin{matrix}\begin{matrix}( {σ}_{X}^{2} + Δ t {σ}_{{Xv}_{x}} + \frac{Δ {t}^{2}}{2} {σ}_{{Xa}_{x}} ) + \\ ( {σ}_{{Xv}_{x}} + Δ t {σ}_{{v}_{x}}^{2} + \frac{Δ {t}^{2}}{2} {σ}_{{v}_{x} {a}_{x}} ) Δ t + \\ ( {σ}_{{Xa}_{x}} + {Δ}^{′} t {σ}_{{v}_{x} {a}_{x}} + \frac{Δ {t}^{2}}{2} {σ}_{{a}_{x}}^{2} ) \frac{Δ {t}^{2}}{2}\end{matrix} & 0 \\ 0 & \begin{matrix}( {σ}_{Y}^{2} + Δ t {σ}_{{Yv}_{y}} + \frac{Δ {t}^{2}}{2} {σ}_{{Ya}_{y}} ) + \\ ( {σ}_{{Yv}_{y}} + Δ t {σ}_{{v}_{y}}^{2} + \frac{Δ {t}^{2}}{2} {σ}_{{v}_{y} {a}_{y}} ) Δ t + \\ ( {σ}_{{Ya}_{y}} + Δ t {σ}_{{v}_{y} {a}_{y}} + \frac{Δ {t}^{2}}{2} {σ}_{{a}_{y}}^{2} ) \frac{Δ {t}^{2}}{2}\end{matrix}\end{matrix} ) + ( \begin{matrix}{σ}_{R}^{2} & 0 \\ 0 & {σ}_{R}^{2}\end{matrix} ) ) \\ = ( \begin{matrix}\begin{matrix}( {σ}_{X}^{2} + Δ t {σ}_{{Xv}_{x}} + \frac{Δ {t}^{2}}{2} {σ}_{{Xa}_{x}} ) + \\ ( {σ}_{{Xv}_{x}} + Δ t {σ}_{{v}_{x}}^{2} + \frac{Δ {t}^{2}}{2} {σ}_{{v}_{x} {a}_{x}} ) Δ t + \\ ( {σ}_{{Xa}_{x}} + Δ t {σ}_{{v}_{x} {a}_{x}} + \frac{Δ {t}^{2}}{2} {σ}_{{a}_{x}}^{2} ) \frac{Δ {t}^{2}}{2} + {σ}_{R}^{2}\end{matrix} & 0 \\ 0 & \begin{matrix}( {σ}_{X}^{2} + Δ t {σ}_{{Xv}_{x}} + \frac{Δ {t}^{2}}{2} {σ}_{{Xa}_{x}} ) + \\ ( {σ}_{{Xv}_{x}} + Δ t {σ}_{{v}_{x}}^{2} + \frac{Δ {t}^{2}}{2} {σ}_{{v}_{x} {a}_{x}} ) Δ t + \\ ( {σ}_{{Xa}_{x}} + Δ t {σ}_{{v}_{x} {a}_{x}} + \frac{Δ {t}^{2}}{2} {σ}_{{a}_{x}}^{2} ) \frac{Δ {t}^{2}}{2} + {σ}_{R}^{2}\end{matrix}\end{matrix} )\end{matrix} \qquad [ Equation 17 ]$$

As shown, the (HPₖ⁻H^{T}+R) term is the diagonal of the matrix shown in Equation 17.

Accordingly, the Kalman filter unit 213 computes the gain matrix Kₖ of the Kalman filter as well as the inverse of the (HPₖ⁻H^{T}+R) term from Equation 15 relatively easily.

After having determined the a priori estimate error covariance Pₖ⁻ and the gain matrix Kₖ, the Kalman filter unit 213 computes the error covariance Pₖ based on the a priori estimate error covariance Pₖ⁻, the gain matrix Kₖ and the output matrix H as shown below in Equation 18.

Pₖ=(1−KₖH)Pₖ⁻ [Equation 18]

The Kalman filter unit 213 then predicts or estimates a state vector Xₖ₊₁ and an a priori estimate error covariance Pₖ₊₁⁻ for state k+1 as shown below in Equations 19 and 20, respectively.

Xₖ₊₁=AXₖ [Equation 19]

Pₖ₊₁⁻=APₖA^{T}+Q [Equation 20]

As shown in Equation 19, the state vector Xₖ₊₁ is generated based on the previous state vector Xₖ and the state-transition model A. As shown in Equation 20, the a priori estimate error covariance Pₖ₊₁⁻ is generated based on the state-transition model A, the error covariance Pₖ, the transpose of the state-transition model A, and the process noise Q.

According to at least some example embodiments, Equations 19 and 20 are time update equations, whereas Equations 14, 15 and 18 are measurement update equations.

Thus, according to at least some example embodiments, the Kalman filter unit 213 performs iterative calculations of the time update equations (Equations 19 and 20) and the measurement update equations (Equations 14 and 18) to provide a more accurate prediction/estimation of the state vector and enhance the horizontal translation (Δx) and the vertical translation (Δy) from the motion estimator 211, thereby attempting to predict a true motion of the image without noise.

According to at least some example embodiments, by performing the above-described iterative calculations, the Kalman filter unit 213 may provide a more accurate estimated value of the state vector Xₖ at time k. And, the state vector Xₖ at time k generated by the Kalman filter unit 213 enables more accurate estimation of the horizontal translation (Δx) and vertical translation (Δy) between the first image IM1 and second image IM2. For example, the Kalman filter unit 213 enhances the horizontal translation (Δx) and vertical translation (Δy).

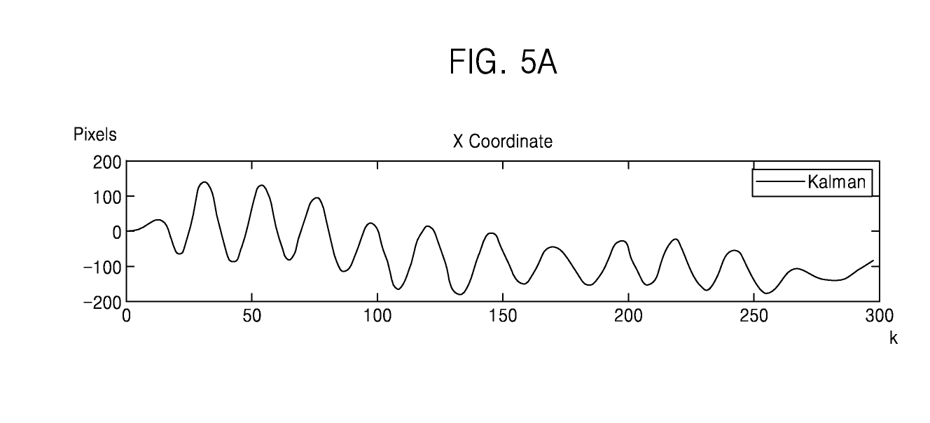

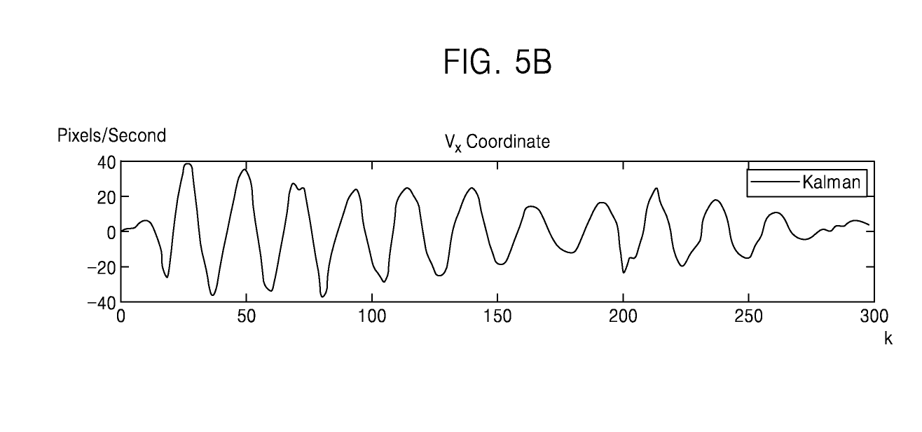

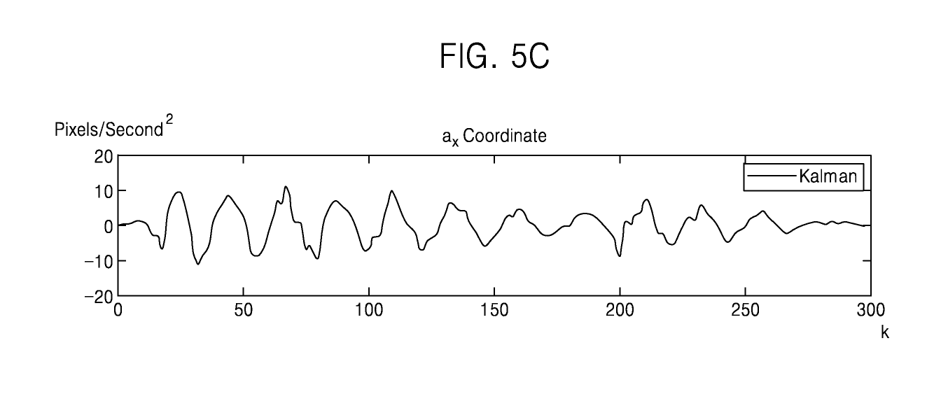

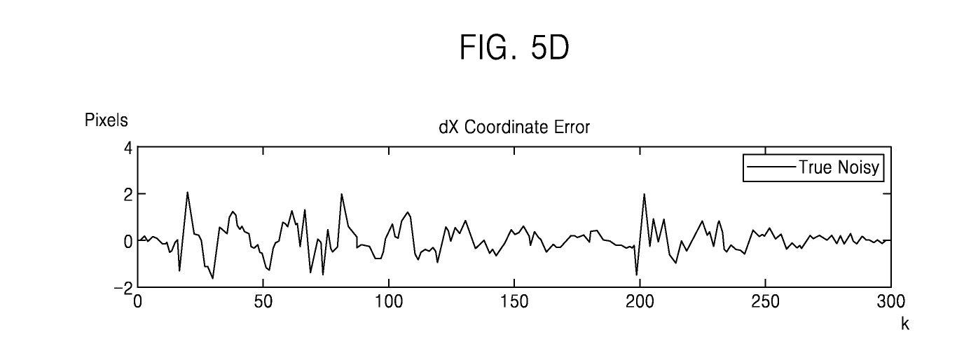

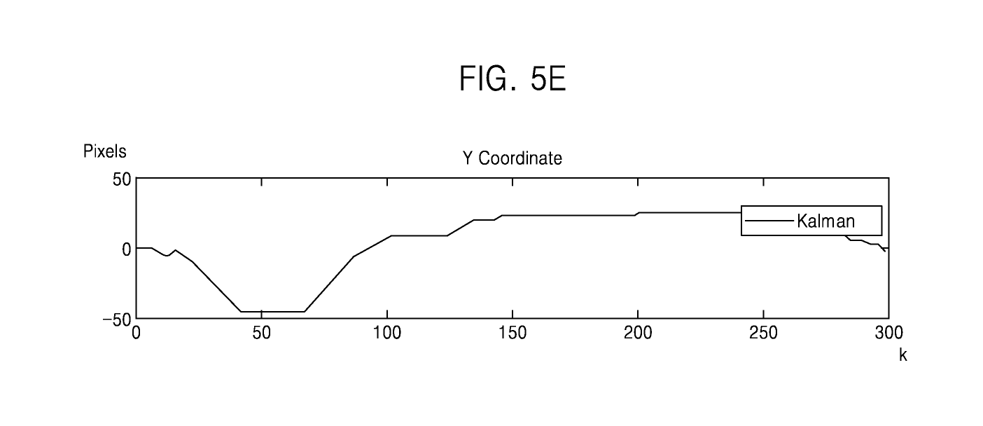

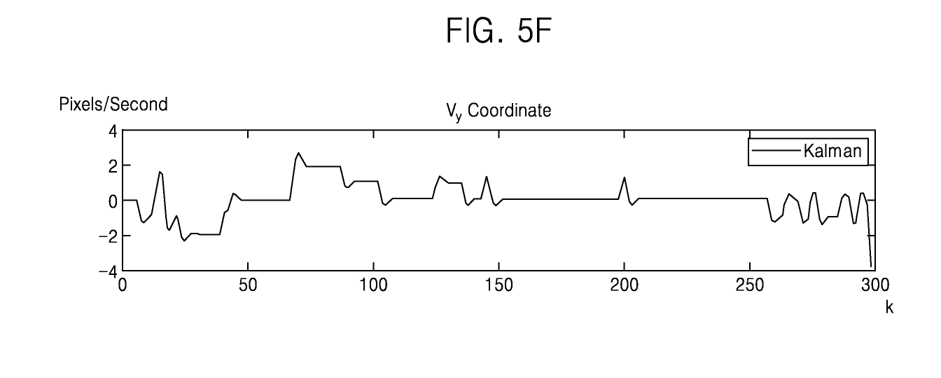

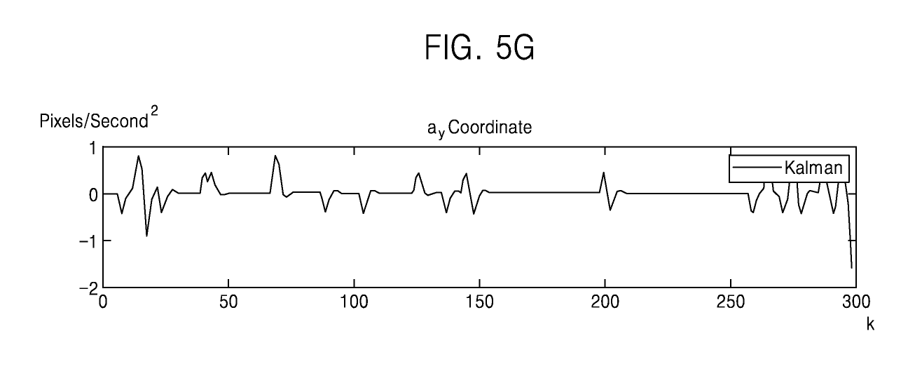

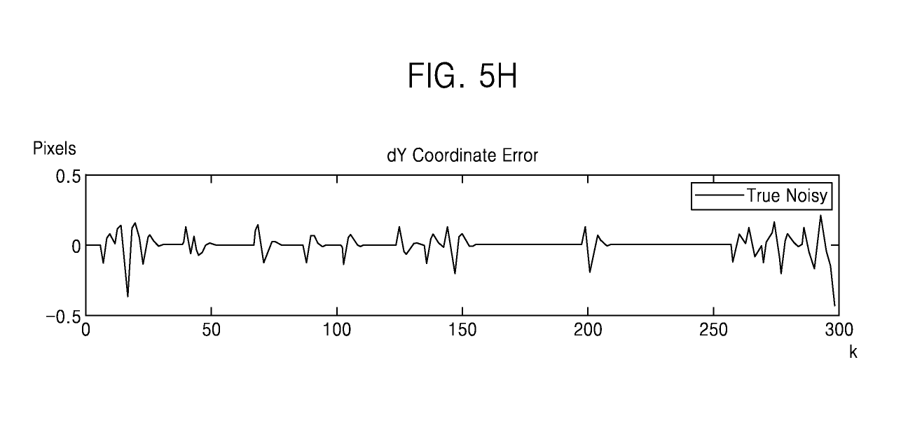

FIGS. 5A to 5H depict simulation graphs for explaining example operation of the Kalman filter illustrated in FIG. 3.

FIG. 5A depicts horizontal displacement according to an increase of a value of k. FIG. 5B depicts horizontal velocities according to an increase of the value of k. FIG. 5C depicts horizontal acceleration according to an increase of the value of k. FIG. 5D depicts a horizontal error according to an increase of the value of k. FIG. 5E depicts vertical displacement according to an increase of the value of k. FIG. 5F depicts vertical velocities according to an increase of the value of k. FIG. 5G depicts vertical acceleration according to an increase of the value of k. FIG. 5H depicts a vertical error according to an increase of the value of k. As shown in FIGS. 5D and 5H, the error becomes more stable as the value of k increases.

Referring back to FIG. 3, the affine transformer 215 rectifies rolling shutter distortion of a second image according to the enhanced horizontal translation (Δx) and enhanced vertical translation (Δy) from the Kalman filter unit 213. That is, for example, the affine transformer 215 applies an inverse affine transformation matrix according to the enhanced horizontal translation (Δx) and the enhanced vertical translation (Δy).

An example inverse affine matrix is depicted as shown below in Equation 21.

$$( \begin{matrix}{C}_{rec}^{th} \\ {R}_{rec}^{th} \\ 1\end{matrix} ) = ( \begin{matrix}1 & - \frac{( Δ x \cdot \frac{( 1 - FPS \cdot {V}_{blank} )}{{\#}_{Rows}} )}{1 + Δ y \cdot \frac{( 1 - FPS \cdot {V}_{blank} )}{{\#}_{Rows}}} & 0 \\ 0 & \frac{1}{1 + Δ y \cdot \frac{( 1 - FPS \cdot {V}_{blank} )}{{\#}_{Rows}}} & 0 \\ 0 & 0 & 1\end{matrix} ) ( \begin{matrix}{C}^{th} \\ {R}^{th} \\ 1\end{matrix} ) \qquad [ Equation 21 ]$$

In Equation 21, C^{th} and R^{th} are a column value and a row value, respectively, C_{rec}^{th} is a rectified column value, R_{rec}^{th} is a rectified row value, Δx is the enhanced horizontal translation, Δy is the enhanced vertical translation, FPS is a frame rate, V_{blank} is a parameter set for an image sensor (100), and #_{Rows} is the number of rows of the image sensor 100.

A size of a second image, which is rectified by the affine transformer 215, may be different from the size of the input second image IM2. Accordingly, to fill in the rectified second image with pixel intensity values, the image signal processor 210 may calculate an original pixel location of the second image IM2 for each output pixel location of the rectified second image. That is, for example, the image signal processor 210 may resize the rectified second image using interpolation. The interpolation may be bilinear interpolation.

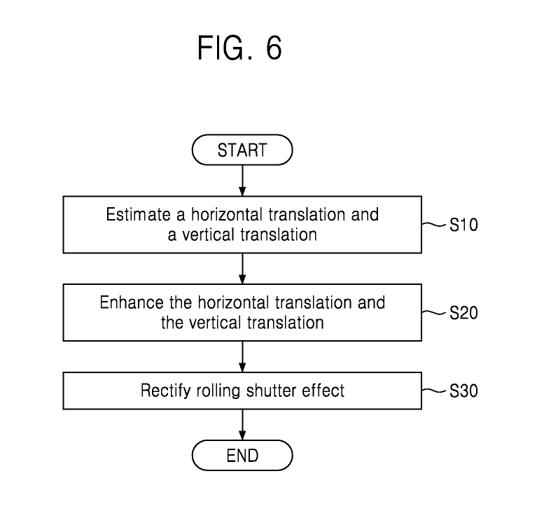

FIG. 6 is a flowchart depicting a method of rectifying rolling shutter effect according to an example embodiment. For example purposes, the flowchart shown in FIG. 6 will be described with regard to the image sensing system shown in FIG. 2.

Referring to FIGS. 2 and 6, at S10 the motion estimator 211 estimates horizontal translation (Δx) and vertical translation (Δy) of a second image 1M2 relative to a first image IM1. At S20, the Kalman filter unit 213 enhances the horizontal translation (Δx) and the vertical translation (Δy) using a Kalman filter. At S30, the affine transformer 215 rectifies rolling shutter distortion of the second image IM2 based on the enhanced horizontal translation (Δx) and the enhanced vertical translation (Δy).

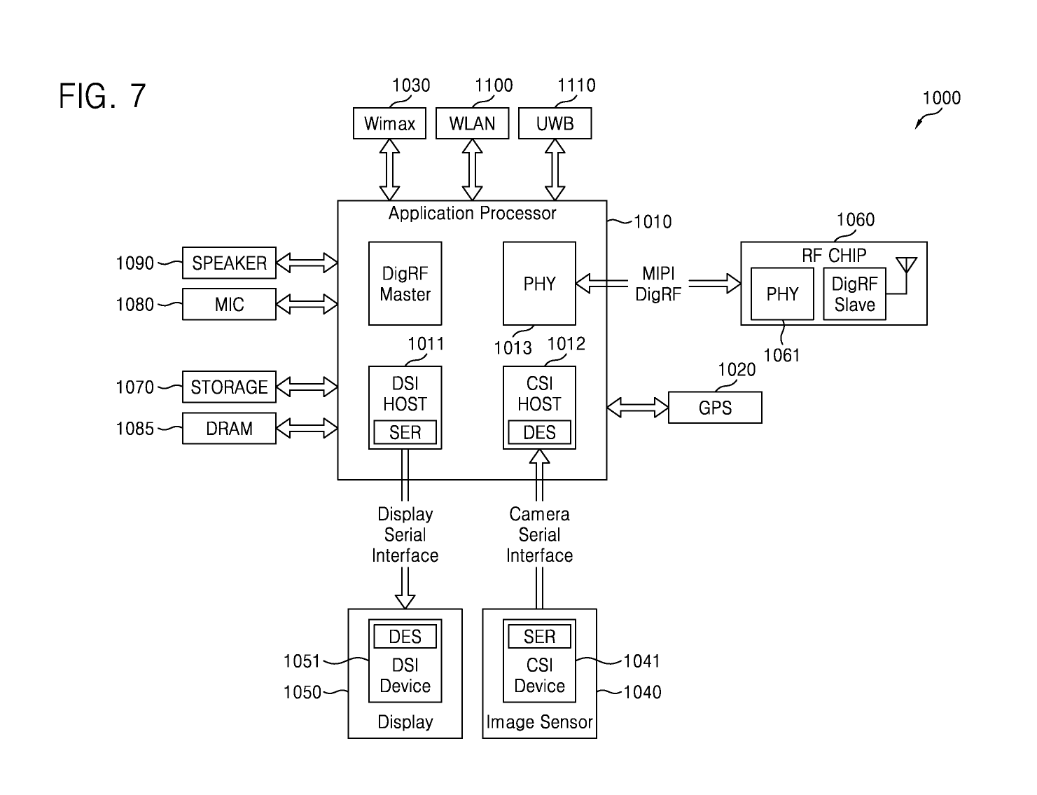

FIG. 7 is a schematic block diagram of an image sensing system according to another example embodiment.

Referring to FIG. 7, an image sensing system 1000 may be embodied in a data processing device, which may use or support a mobile industry processor interface (MIPI), such as a mobile phone, a personal digital assistant (PDA), a portable multimedia player (PMP), a smart phone, a tablet personal computer (PC), or the like.

The image sensing system 1000 includes an application processor 1010, an image sensor 1040 and a display 1050.

A CSI host 1012 embodied in the application processor 1010 may perform serial communication with a CSI device 1041 of the image sensor 1040 through a camera serial interface (CSI). In this example, an optical deserializer may be embodied in the CSI host 1012 and an optical serializer may be embodied in the CSI device 1041. The application processor 1010 may perform a method for rectifying rolling shutter effect according to example embodiments.

A DSI host 1011 embodied in the application processor 1010 may perform serial communication with a DSI device 1051 of the display 1050 through a display serial interface (DSI). In this example, an optical serializer may be embodied in the DSI host 1011 and an optical deserializer may be embodied in the DSI device 1051.

The image sensing system 1000 further includes a RF chip 1060, which may communicate with the application processor 1010. A PHY 1013 of the image sensing system 1000 and a PHY 1061 of the RF chip 1060 may transmit or receive data according to MIPI DigRF.

The image sensing system 1000 further includes a global positioning system (GPS) receiver 1020, a storage 1070, a microphone 1080, a dynamic random access memory (DRAM) 1085 and a speaker 1090. The image sensing system 1000 may communicate by using Worldwide Interoperability for Microwave Access (WiMAX) 1030, a wireless local area network (WLAN) 1100, ultra wideband (UWB) 1110, Universal Mobile Telecommunications Systems (UMTS); Global Systems for Mobile communications (GSM); code division multiple access (CDMA) systems; High Rate Packet Data (HRPD) systems; ultra mobile broadband (UMB); 3^{rd} Generation Partnership Project Long Term Evolution (3GPP LTE); and the like.

Methods for rectifying rolling shutter effects according to at least some example embodiments may reduce complexity of hardware and/or software of an image signal processor by using a Kalman filter.

Although some example embodiments have been shown and described, it will be appreciated by those skilled in the art that changes may be made in these example embodiments without departing from the principles and spirit of inventive concepts, the scope of which is defined in the appended claims and their equivalents.

What is claimed is:

1. A method for rectifying rolling shutter distortion in an image signal processor, the method comprising:
estimating a horizontal translation and a vertical translation of a second image relative to a first image;
filtering the horizontal translation and the vertical translation using a Kalman filter; and
rectifying rolling shutter distortion of the second image based on the filtered horizontal translation and vertical translation.

2. The method of claim 1, further comprising:
capturing the first image and the second image with an image sensor.

3. The method of claim 1, further comprising:
resizing the rectified second image using interpolation.

4. The method of claim 3, wherein the interpolation is bilinear interpolation.

5. The method of claim 1, wherein the rectifying of the rolling shutter distortion comprises:
applying an inverse affine transformation matrix according to the filtered horizontal translation and the filtered vertical translation.

6. The method of claim 1, wherein the first image and the second image are successive images.

7. The method of claim 1, wherein the filtering of the horizontal and vertical translations comprises:
iteratively calculating a state vector indicative of the filtered horizontal and vertical translations; and
determining the filtered horizontal and vertical translations based on the iteratively calculated state vector.

8. An image signal processor comprising:
a motion estimator configured to estimate a horizontal translation and a vertical translation of a second image relative to a first image;
a Kalman filter unit configured to filter the horizontal translation and the vertical translation; and
an affine transformer configured to rectify rolling shutter distortion of the second image based on the filtered horizontal translation and the filtered vertical translation.

9. The image signal processor of claim 8, further comprising:
a controller configured to control an image sensor configured to capture the first image and the second image.

10. The image signal processor of claim 8, further comprising:
a frame buffer configured to store the first image and the second image.

11. The image signal processor of claim 8, wherein the Kalman filter unit is configured to iteratively calculate a state vector indicative of the filtered horizontal and vertical translations, and to determine the filtered horizontal and vertical translations based on the iteratively calculated state vector.

12. An image sensing system comprising:
the image signal processor of claim 8; and
a display unit configured to display images output from the image signal processor.

13. The image sensing system of claim 12, further comprising:
an image sensor configured to capture the first image and the second image.

14. The image sensing system of claim 12, further comprising:
a frame buffer configured to store the first image and the second image.

15. A method for rectifying rolling shutter effects between a first image and a second image, the method comprising:
predicting, by an image signal processor, motion between the first image and the second image by estimating a horizontal and vertical shift between the first image and the second image using a Kalman filter; and
rectifying, by the image signal processor, rolling shutter distortion of the second image based on the predicted motion.

16. The method of claim 15, further comprising:
determining an initial estimate of the horizontal and vertical shift between the first image and the second image; and wherein
the motion is predicted based on the determined initial estimate.

17. The method of claim 15, wherein the rectifying of the rolling shutter distortion comprises:
applying an inverse affine transformation matrix based on the estimated horizontal and vertical shift.

18. The method of claim 15, wherein the first image and the second image are successive images.

19. The method of claim 15, wherein the estimating of the horizontal and vertical shift comprises:
iteratively calculating a state vector indicative of the estimated horizontal and vertical shift.

20. The method of claim 19, wherein a current value of the state vector is iteratively calculated based on previously calculated values of the state vector.
